(19) United States
(12) Patent Application Publication
(10) Pub. No.: US 2020/0171792 A1
(43) Pub. Date: Jun. 4, 2020

(54) LAMINATED BODY AND METHOD FOR PRODUCING SAME

(71) Applicant: TOYOTA BOSHOKU KABUSHIKI KAISHA, Aichi (JP)

(72) Inventors: Tatsuo NAITO, Aichi (JP); Masakazu KITO, Aichi (JP)

(73) Assignee: TOYOTA BOSHOKU KABUSHIKI KAISHA, Aichi (JP)

(21) Appl. No.: 16/699,163

(22) Filed: Nov. 29, 2019

(30) Foreign Application Priority Data
Dec. 3, 2018 (JP) 2018-226564

(51) Int. Cl. B32B 7/12; B32B 5/02; B32B 5/24; B32B 37/12; C09J 11/06; C09J 123/26

(52) U.S. Cl. CPC B32B 7/12; B32B 5/022; B32B 5/024; B32B 5/026; B32B 2037/1253; B32B 37/12; C09J 11/06; C09J 123/26; B32B 5/24

(57) ABSTRACT

Disclosed herein is a laminated body including an adhesive layer containing a cross-linked modified resin obtained by forming a cross-link derived from a cross-linkable group of a thermoplastic resin having the cross-linkable group, and a catalyst impregnated into the cross-linked modified resin, wherein the catalyst promotes formation of a cross-link derived from the cross-linkable group, and wherein when a solubility parameter of an adhesive main agent containing the thermoplastic resin having the cross-linkable group is defined as SP₁ and a solubility parameter of the catalyst is defined as SP₂, an absolute difference between the SP₁ and the SP₂ represented as |SP₁−SP₂| is 4.5 or less.

### CROSS-REFERENCE TO RELATED APPLICATION

The present application claims priority under 35 U.S.C. $119 to Japanese Patent Application No. 2018-226564 filed on Dec. 3, 2018, the disclosure of which is incorporated herein by reference in its entirety.

### BACKGROUND OF THE INVENTION

### (1) Field of the Invention

The present invention relates to a laminated body having two adherends and an adhesive layer interposed between these adherends to bond them together, and a method for producing the same.

### (2) Description of Related Art

Various adhesive agents are conventionally used to bond various adherends to form laminated bodies. Depending on the materials of adherends and the intended use of a bonded body, an adhesive agent is selected from hot-melt adhesives (see, for example, JP 2018-100022 A), aqueous adhesives, solvent-based adhesives, and the like, and depending on a desired adhesive strength, a synthetic resin or the like serving as a base compound of the adhesive agent is selected. Further, the adhesive agent to be used is appropriately selected also depending on a method for applying it onto an adherend, a temperature and pressure at which adherends are bonded together, pot life, an open time, and the like.

Among the above-mentioned various adhesives, aqueous adhesives and solvent-based adhesives are poor in transport efficiency because their solid content is often about 50% by mass at most. Further, from an environmental viewpoint, solvent-based adhesives have a problem that organic solvents evaporate in a drying step or the like performed after application onto adherends.

### SUMMARY OF THE INVENTION

Hot-melt adhesives are preferred in that their transport efficiency is very high because their solid content is almost 100% and that environmental problems caused by organic solvents do not arise at all. Hot-melt adhesives include reactive-type hot-melt adhesives and non-reactive-type hot-melt adhesives. A reactive-type hot-melt adhesive functions as an adhesive agent by curing a reactive-curable base compound. Therefore, a long pot life results in a long curing time, that is, pot life tends to be a trade-off with an aging time.

On the other hand, a non-reactive-type hot-melt adhesive functions as the adhesive agent by solidifying a melted thermoplastic resin, or the like. In the case of a non-reactive-type hot-melt adhesive, a melted adhesive is applied onto an adherend, but the melted adhesive is often a melted thermoplastic resin, and therefore has a very high melt viscosity. Therefore, an application method is limited to, for example, a method in which a melted resin is applied onto an adherend with the use of an extrusion molding machine or the like. Further, in order to obtain a bonded body having high heat resistance, a thermoplastic resin having a high melting point needs to be used. In this case, after the adhesive agent is applied onto one of adherends, the other adherend needs to be bonded thereto as soon as possible. That is, an open time is short. Therefore, the heat resistance of the adhesive agent tends to be a trade-off with the open time.

In view of the above-described problems of prior arts, it is an object of the present invention to provide an efficient production method of a laminated body in which two adherends are bonded each other, and a laminated body obtained by the method.

The present invention provides the following.

1. A laminated body comprising two adherends and an adhesive layer that is interposed between these adherends to bond them together,

wherein the adhesive layer comprises
a cross-linked modified resin obtained by forming a cross-link derived from a cross-linkable group of a thermoplastic resin having the cross-linkable group, and
a catalyst impregnated into the cross-linked modified resin,

wherein the catalyst promotes formation of a cross-link derived from the cross-linkable group, and

wherein when a solubility parameter of an adhesive main agent containing the thermoplastic resin having the cross-linkable group is defined as SP₁ and a solubility parameter of the catalyst is defined as SP₂, |SP₁−SP₂| is 4.5 or less.

2. The laminated body according to 1 above, wherein at least one of the two adherends has a porous adherend surface.
3. The laminated body according to 2 above, wherein the adherend is at least one of a fiber assembly sheet, a fiber assembly board, and a resin board.
4. The laminated body according to 2 above, wherein the adherend is at least one of a woven cloth, a knitted cloth, and a non-woven cloth.
5. The laminated body according to any one of 2 to 4 above, which is an interior material.

The interior material is preferably one in which the adhesive layer and a woven cloth are laminated in this order on a surface of the fiber assembly sheet or the fiber assembly board.

6. The laminated body according to any one of 2 to 4 above, which is an exterior material.

The exterior material is preferably one in which the adhesive layer and a resin film are laminated in this order on a surface of the fiber assembly board.

7. The laminated body according to any one of 1 to 6 above, wherein the |SP₁−SP₂| is 3 or less.
8. The laminated body according to any one of 1 to 7 above, wherein the catalyst is a compound having a molecular weight of 500 or less.
9. The laminated body according to any one of 1 to 8 above, wherein the catalyst is an amine-based compound.
10. The laminated body according to claim 9, wherein the amine-based compound is at least one selected from a group consisting of bis-(2-dimethylaminoethyl) ether, N,N, N′,N′-tetramethylhexamethylenediamine, 1-methyl-4′-(dimethylaminoethyl)piperazine, N,N,N′,N′-tetramethylethylenediamine, and N,N-dimethyldodecylamine.
11. The laminated body according to claim 1, wherein the thermoplastic resin having a cross-linkable group is a polyolefin having an alkoxysilyl group.
12. The laminated body according to any one of 1 to 11 above, wherein the adhesive layer has a thickness of 10 to 500 μm.
13. A method for producing a laminated body according to any one of 1 to 12 above, the method comprising:

an adhesive layer forming step in which an adhesive layer containing a thermoplastic resin having a cross-linkable group and a catalyst is formed;

an interposing step in which the adhesive layer is interposed between two adherends; and

a pressing step in which the two adherends and the adhesive layer are heated and pressed in a layer thickness direction,

wherein when a solubility parameter of an adhesive main agent containing the thermoplastic resin having a cross-linkable group is defined as SP₁ and a solubility parameter of the catalyst is defined as SP₂, |SP₁−SP₂| is 4.5 or less.

14. The method for producing a laminated body according to 13 above, wherein the thermoplastic resin having a cross-linkable group is a polyolefin having an alkoxysilyl group.

It is to be noted that the unit of the solubility parameter (SP value) is (cal/cm³)^{1/2}).

The laminated body of the present invention is one in which two adherends are bonded with an adhesive layer containing a specific cross-linked modified resin and a catalyst that satisfies |SP₁−SP₂| of 4.5 or less. Therefore, the laminated body has high quality because the two adherends are uniformly bonded in a planar direction.

In the case where at least one of the two adherends has a porous adherend surface, the adhesive enters into pores of the adherend surface so that an anchor effect is exerted, and therefore the laminated body can have a higher adhesive strength such as peel strength.

In the case where the adherend is a fiber assembly sheet, a fiber assembly board or a resin board and is used as a base layer of an interior or exterior material for vehicles, a product having sufficient strength can be obtained.

In the case where the adherend is at least one of a woven cloth, a knitted cloth, and a non-woven cloth and is used as a surface skin layer serving as a design surface of an interior or exterior material for vehicles, a product can be obtained in which the surface skin layer is sufficiently strongly bonded to a base layer.

In the case where the laminated body is used as an interior or exterior material, for example, in a case of an interior material in which an adhesive layer and a woven cloth are laminated in this order on a fiber assembly sheet, a fiber assembly board or a resin board, or a case of an exterior material in which an adhesive layer and a resin film are laminated in this order on a fiber assembly board, the interior material and exterior material are uniform, and the laminated body leads to an interior material having a useful design surface, and to an exterior material having sufficient strength.

In the case where the |SP₁−SP₂| is 3 or less, the catalyst more easily permeates into the adhesive main agent.

In the case where the catalyst is a compound having a molecular weight of 270 or less, the catalyst easily diffuses in the adhesive main agent, and therefore an adhesive layer can more easily be formed due to the permeation and diffusion of the catalyst into and in the adhesive main agent.

In the case where the catalyst is an amine-based compound, a compound whose molecular weight and solubility parameter difference are both small can easily be selected, and therefore the catalyst that can easily permeate into the adhesive main agent can be selected from a wide range.

In the case where the amine-based compound is at least one of the above-mentioned various compounds, the compound particularly has a small molecular weight and a small solubility parameter, and therefore can easily permeate as a catalyst into the adhesive main agent.

In the case where the thermoplastic resin having a cross-linkable group is a polyolefin having an alkoxysilyl group, a siloxane cross-linked modified polyolefin that constitutes the adhesive layer can easily be formed.

In the case where the adhesive layer has a thickness of 10 to 500 μm, the catalyst can more easily permeate into and diffuse in the adhesive main agent, and therefore the adhesive layer can exert sufficient adhesive strength.

According to the present invention, a hot-melt adhesive that includes a reactive curable adhesive main agent consisting of a thermoplastic resin having a crosslinkable group and a catalyst, that has high transport efficiency, and that causes no environmental problem resulting from organic solvents in the adhesive layer forming step. And when the adhesive main agent is brought into contact with a catalyst to allow the catalyst to permeate into the adhesive main agent so that sufficient pot life can be achieved and a time required for curing, that is, an aging time can be reduced. Therefore, a laminated body can be efficiently produced.

Further, when the thermoplastic resin having a cross-linkable group is a polyolefin having an alkoxysilyl group, cross-linking is quickly performed, and therefore a laminated body can easily be produced in which two adherends are strongly bonded.

### DETAILED DESCRIPTION OF PREFERRED EMBODIMENTS

Hereinbelow, the present invention will be described in detail.

The particulars shown herein are by way of example and for purposes of illustrative discussion of the embodiments of the present invention only, and presented in the cause of providing what is believed to be the most useful and readily understood description of the principles and conceptual aspects of the present invention. In this regard, no attempt is made to show structural details of the present invention in more detail than is necessary for the fundamental understanding of the present invention, and the description makes apparent to those skilled in the art how the several forms of the present invention may be embodied in practice.

### [1] Laminated Body

A laminated body of the present invention is an article that includes two adherends and an adhesive layer that is interposed between these adherends to bond them together, and one in which the adhesive layer contains a cross-linked modified resin obtained by forming cross-links derived from a cross-linkable group of a thermoplastic resin having the cross-linkable group, and a catalyst impregnated into the cross-linked modified resin. The laminated body of the present invention is one obtained by “Production method of a laminated body” that is to be described later, and is characterized in that a difference between the SP₁ and the SP₂ represented as |SP₁−SP₂| is 4.5 or less when a solubility parameter of an adhesive main agent containing a thermoplastic resin having a cross-linkable group is defined as SP₁ and a solubility parameter of the catalyst is defined as SP₂. In the present invention, since the difference between the solubility parameter of the adhesive main agent and the solubility parameter of the catalyst is small, the laminated body of the present invention is an integrated body having an excellent adhesiveness.

### [2] Adherend

Two adherends are not particularly limited, and various adherends can be used. It is particularly preferable that at least one adherend has a porous surface. The two adherends are not particularly limited, and various adherends can be used. However, an adherend having a porous adherend surface is particularly preferred. When the adherend surface is porous, an adhesive constituting the adhesive layer enters into pores of the adherend surface so that a so-called anchor effect is exerted in addition to adhesive effect that the adhesive originally has, and therefore adhesive strength such as peel strength can further be enhanced.

Examples of the adherend having a porous adherend surface include a fiber assembly sheet, a fiber assembly board, a resin board, and the like. The fiber assembly sheet and fiber assembly board are not particularly limited. A sheet or board made of various materials can be used in various forms. The fiber assembly sheet and fiber assembly board can be used which is formed by, for example, blending a synthetic resin fiber, a plant fiber, and an inorganic fiber such as a glass fiber and a carbon fiber to form a web, interlacing these fibers to form a fiber mat, and then applying a dispersion that is obtained by dispersing an acid-modified resin powder or the like in an aqueous medium onto the fiber mat to impregnate the dispersion into the fiber mat to bind the interlaced fibers together. The resin board is not particularly limited, either, and boards obtained by molding various synthetic resins by extrusion molding or the like can be used. A fiber assembly sheet, a fiber assembly board, or a resin board is useful as, for example, a base material of an interior material such as an interior and exterior material for vehicles.

Additionally, other examples of the adherend having a porous adherend surface include a woven cloth, a knitted cloth, and a non-woven cloth. Examples of fibers used for fabrics such as cloths including woven cloths, knitted cloths, and non-woven cloths include natural fibers such as cotton, hemp, sheep wool, and silk, regenerated fibers such as cupra and rayon, semisynthetic fibers such as acetate, synthetic resin fibers such as polyester-based fibers, acrylic fibers, polyamide-based fibers, and polyolefin-based fibers, composite fibers using these fibers, and blended fibers. A fabric is useful as, for example, a surface skin material for an interior material for vehicles.

It is to be noted that the adherend to be used may be a thermoplastic resin sheet, but the thermoplastic resin sheet usually has a smooth surface, and therefore an anchor effect is not exerted. A thermoplastic resin used for forming the thermoplastic resin sheet is not particularly limited as long as it can be formed into a sheet by extrusion molding, injection molding, or the like, and various resins can be used. Examples of such a thermoplastic resin include a polyolefin resin, a polyamide resin, a polyester resin, and a polyacrylic resin. As the adherend, a natural leather, a synthetic leather, or the like may also be used although an anchor effect is not exerted as in the case of the thermoplastic resin sheet.

### [3] Adhesive Layer

The adhesive layer is a layer including a crosslinked modified resin obtained by forming a cross-link derived from a cross-linkable group of a thermoplastic resin having the cross-linkable group, and a catalyst. This adhesive layer is, to be explained below in “production method of a laminated body”, a layer that is formed by contacting a catalyst and a thermoplastic resin having a crosslinkable group when the catalyst and an adhesive main agent containing the thermoplastic resin having a crosslinkable group. The adhesive layer can be prepared, for example, by using an adhesive main agent containing a catalyst, or by forming a layer using an adhesive main agent containing no catalysts and then applying a catalyst on the layer. Examples of the cross-linkable group in the thermoplastic resin having a crosslinkable group contained in the adhesive main agent include an alkoxysilyl group, an oxazoline group, an acid anhydride group, a carbodiimide group, and the like. In the present invention, an alkoxysilyl group having a low cohesive strength is preferred. Examples of the alkoxysilyl group include a trimethoxysilyl group, a methyldimethoxysilyl group, a dimethylmethoxysilyl group, a triethoxysilyl group, a methyldiethoxysilyl group, a methylmethoxyethoxysilyl group, and the like. Among these, a trimethoxysilyl group, and a methyldimethoxysilyl group are preferable from a viewpoint of curing rate and the like.

The thermoplastic resin preferably has a skeleton of a polyolefin, a polyurethane, or an acrylic resin. In the case of a polyolefin, a homopolymer or a copolymer may be used. Examples of an olefin (olefin monomer) forming the polyolefin include ethylene, propylene, 1-butene, 1-pentene, 3-methyl-1-pentene, 4-methyl-1-pentene, 3-methyl-1-butene, 1-hexene, 1-octene, and the like. A polyolefin having a crosslinkable group is one in which a crosslinkable group derived from an alkoxysilane is bonded to a polymer of an olefin monomer.

A polyethylene and a polypropylene are widely used as an olefin homopolymer. Examples of the copolymer include a copolymer of ethylene and 1-butene, propylene, 1-hexene,1-octene, or 4-methyl-1-pentene. A copolymer of ethylene and propylene is generally used as the copolymer. There are a random copolymer and a block copolymer, however, a block copolymer is preferable from a viewpoint of excellent impact resistance. The polyolefin may be used singly or in combination of two or more types thereof.

The thermoplastic resin having a crosslinkable group is preferably a polyolefin having an alkoxysilyl group. In this case, a content thereof in the adhesive main agent is not particularly limited, but is preferably 10% by mass or more (may be 100% by mass), more preferably 30% by mass or more, and particularly 40% by mass or more, based on 100% by mass of the adhesive main agent.

When the thermoplastic resin having a crosslinkable group is preferably a polyolefin having an alkoxysilyl group, a crosslinked modified resin in the adhesive layer contains a crosslinked olefin resin having a siloxane crosslink.

In the present invention, the catalyst is a component that promotes formation of cross-links derived from the cross-linkable groups. The catalyst can appropriately be selected depending on types of the cross-linkable group used and types of thermoplastic resin used. For example, when the cross-linkable group is an alkoxysilyl group and the thermoplastic resin is a polyolefin, the catalyst that promotes formation of a siloxane cross-link derived from the alkoxysilyl group may be, for example, an amine-based compound or a metallic catalyst. Examples of the amine-based compound to be used include a monoamine compound, a diamine compound, a triamine compound, a cyclic amine compound, an alcohol amine compound, an ether amine compound, and a reactive-type amine-based compound obtained by hydroxylating or aminating part of the structure of each of these compounds to allow a reaction with a polyisocyanate.

Specific examples of the amine-based compound include methanolamine, ethanolamine, propanolamine, N-methylmethanolamine, N-methylethanolamine, N-methylpropanolamine, N,N-dimethylmethanolamine, N,N-dimethylethanolamine, N,N-diethylethanolamine, N,N-dipropylethanolamine, N,N-dimethylbutanolamine, N,N-diethylbutanolamine, N,N-dipropylbutanolamine, N-(aminomethyl)methanolamine, N-(aminomethyl)ethanolamine, N-(aminomethyl)propanolamine, N-(aminoethyl)methanolamine, N-(aminoethyl)ethanolamine, and N-(aminoethyl)propanolamine.

Other specific examples of the amine-based compound include triethylamine, N,N-dimethylcyclohexylamine, triethylenediamine, N,N,N′,N′-tetramethylethylenediamine, tetramethylguanidine, N,N-dipolyoxyethylenestearylamine, N,N′-dimethylpiperazine, N-methyl-N′-(2-dimethylamino)-ethylpiperazine, N-methylmorpholine, N-ethylmorpholine, N—(N′,N′-dimethylaminoethyl)-morpholine, and 1,2-dimethylimidazole. These amine-based compounds constituting the catalyst may be used singly or in combination of two or more of them.

As the amine-based compound, these various compounds mentioned above as examples may be used. However, the amine-based compound is preferably a tertiary amine, and a substituent linked to the nitrogen atom of a tertiary amine is preferably a methyl group. The amine-based compound is preferably a polyamine. Examples of such an amine-based compound include bis-(2-dimethylaminoethyl) ether (SP value; 8.1, molecular weight; 160.0), N,N,N′,N′-tetramethylhexamethylenediamine (SP value; 8.0, molecular weight; 172.3), 1-methyl-4′-(dimethylaminoethyl)piperazine (SP value; 8.9, molecular weight; 171.3), N,N-dimethyldodecylamine (SP value; 8.0, molecular weight; 213.4), and N,N′,N″-tris(3-dimethylaminopropyl)hexahydro-s-triazine (SP value; 8.9, molecular weight; 342.6).

Examples of the metallic catalyst include organometallic compounds such as carboxylates of metals such as tin, zinc, iron, lead, cobalt, and titanium. These metallic catalysts may be used singly or in combination of two or more of them.

In the adhesive layer according to the present invention, a catalyst is impregnated in the cross-linked modified resin. The catalyst is preferably dispersed in the whole of the adhesive layer. The laminated body of the present invention has an adhesive layer having such a preferable embodiment.

In the present invention, when the solubility parameter of the adhesive main agent is defined as SP₁, and the solubility parameter of the catalyst is defined as SP₂, an absolute difference between the SP values represented as |SP₁−SP₂| is 4.5 or less. The difference satisfies preferably (SP₁−SP₂|≤4.0, more preferably |SP₁−SP₂|≤3, further preferably |SP₁−SP₂|≤2.8, even more preferably |SP₁−SP₂)≤2.0, and particularly |SP₁−SP₂|≤1.0.

It is to be noted that the SP value is calculated by a method described in the Fedors method (Polymer Engineering and Science, February, 1974, Vol. 14, No. 2, pp. 147 to 154).

The catalyst more easily diffuses when having a smaller molecular weight. Therefore, the molecular weight of the catalyst is preferably small to an extent that the function of the catalyst does not deteriorate. Depending on the kind of catalyst used, the molecular weight of the catalyst is preferably 500 or less, more preferably 320 or less, even more preferably 270 or less, and particularly 230 or less. Further, the molecular weight of the catalyst is preferably 35 or more, more preferably 55 or more, even more preferably 80 or more, and particularly 100 or more.

As mentioned above, the catalyst is preferably of a compound that has a small solubility parameter difference against the adhesive main agent and has a small molecular weight. The solubility parameter (SP₂) of the catalyst to be used depends on types of the adhesive main agent, but is usually in a range from 5 to 14, preferably from 5 to 12, more preferably from 6 to 11, further preferably from 6 to 10.5, and particularly from 7 to 9.5. When the thermoplastic resin having a crosslinkable group is a polyolefin having an alkoxysilyl group, and the catalyst has such a solubility parameter and a molecular weight in the above-mentioned preferable range, an adhesive layer in the laminated body contains a crosslinked olefin resin having a siloxane crosslink and has an excellent adhesiveness.

A content of the catalyst in the adhesive layer is not particularly limited, but is preferably in a range from 0.1% to 5.0% by mass, and particularly from 0.5% to 2.0% by mass based on 100% by mass of a total with the crosslinked resin from a viewpoint of adhesiveness of the adherends.

The thickness of the adhesive layer can appropriately be set depending on types of adherend and the intended use of the laminated body, and may be, for example, in a range from 10 to 500 μm. A lower limit of the thickness is preferably 20 μm, more preferably 50 μm, and further preferably 70 μm. An upper limit of the thickness is preferably 400 μm, more preferably 300 μm, and further preferably 200 μm. When the two adherends are porous and are fiber products that are same or different each other, the adhesive layer may not be present in the laminated body. The laminated body sometimes has an embodiment in which fiber(s) in one adherend contacting with fiber(s) in other adherend are just bonded.

### [4] Intended Use of Laminated Body

The laminated body of the present invention is an integrated body with an adhesive layer, and is a preferably a laminate in which the adhesive layer is sandwiched between a base material and a surface material. The laminated body is widely used for products in, for example, vehicle-related fields and architecture-related fields. In vehicle-related fields, laminated bodies are used as, for example, interior, exterior, and structural materials of vehicles, such as door trims, pillar garnishes, seat back boards, roof trims, instrument panels, console boxes, dashboards, and deck trims. Further, various laminated bodies are used also for various means of transportation and conveyance such as railway vehicles, boats and ships, and airplanes.

In architecture-related fields, laminated bodies are suitably used as, for example, interior, exterior, and structural materials of various architectural structures. For example, laminated bodies different in materials are used in various forms as door surface materials, door structural materials, and surface materials and structural materials of various articles of furniture (e.g., desks, chairs, racks, and chests of drawers).

### [5] Production Method of Laminated Body

The production method of a laminated body of the present invention has an adhesive layer forming step in which an adhesive main agent including a thermoplastic resin having a crosslinkable group and a catalyst to form an adhesive layer, an interposing step in which the adhesive layer is interposed between two adherends, and a pressing step in which the two adherends and the adhesive layer are heated and pressed in a layer thickness direction.

Therefore, the present invention is a production method of a laminated body using a two-part adhesive. Preferable conditions in each step are appropriately set depending on the kind of adherend, an intended adhesive strength such as a peeling strength between a formed adhesive layer and the adherend, or the like.

The thermoplastic resin having a crosslinkable group and catalyst used in the adhesive layer forming step are exemplified as described above. The thermoplastic resin having a crosslinkable group is preferably a polyolefin having an alkoxysilyl group. The catalyst used in the present invention is one consisting of a component in which an absolute value of a difference between the solubility parameter SP₂ of the catalyst and a solubility parameter SP₁ of the adhesive main agent is 4.5 or less from a view point that the catalyst can be promptly and uniformly impregnated into the adhesive main agent and diffused in it.

A content of the thermoplastic resin having a crosslinkable group in the adhesive main agent is not particularly limited, but is preferably 10% by mass or more, more preferably 30% by mass or more, and particularly 40% by mass or more, based on 100% by mass of the adhesive main agent. The adhesive main agent may be consisting of the thermoplastic resin having a crosslinkable group.

A usage amount of the catalyst is not particularly limited and may be set depending on a type of the thermoplastic resin having a crosslinkable group, a type and bonding rate of the crosslinkable group, an intended adhesive strength, and the like.

The amount is preferably in a range from 0.1% to 5.0% by mass, and particularly from 0.5% to 2.0% by mass based on 100% by mass of a total amount with the thermoplastic resin having a crosslinkable group. When the catalyst is used in the above ranged amount in a case where the thermoplastic resin having a crosslinkable group is a polyolefin having an alkoxysilyl group, an olefin resin having a siloxane cross-link can be efficiently formed. If the usage amount of the catalyst is small, a cross-link may not be formed and an intended adhesive strength such as peeling strength may not be obtained.

The thickness of the adhesive layer formed in the adhesive layer forming step may be set in consideration of types or material of the adherend, an open time, and a time required to develop a desired adhesive strength such as peel strength, that is, an aging time.

In the adhesive layer forming step, an adhesive layer can be obtained by applying an adhesive agent including an adhesive main agent containing a thermoplastic resin having a crosslinkable group and a catalyst onto an adherend surface. Or, an adhesive layer can be obtained by applying an adhesive main agent containing a thermoplastic resin having a crosslinkable group onto an adherend surface to form a main agent layer, and then applying a catalyst to the main agent layer to allow the catalyst to permeate into the main agent layer (hereinafter, referred to as “method (1)”). Additionally, an adhesive layer can be obtained by applying a catalyst onto an adherend surface, and then applying an adhesive main agent containing a thermoplastic resin having a crosslinkable group to form a main agent layer and allow the catalyst to permeate into the main agent layer (hereinafter, referred to as “method (2)”). Further, an adhesive layer can be obtained by applying an adhesive main agent onto a surface of one adherend to form a main agent layer, applying a catalyst onto a surface of the other adherend, and laminating the two adherends in the interposing step to contact the main agent layer and the catalyst (hereinafter, referred to as “method (3)”). In the method (3), the catalyst is impregnated to the main agent layer after laminating to form an adhesive layer.

The interposing step in which the adhesive layer is interposed between two adherends is a step in which, depending on a method for forming the adhesive layer in the adhesive layer forming step, one of the adherends, the adhesive layer, and the other adherend are laminated in this order that the adhesive layer is interposed between the one of the adherends and the other adherend. An adhesive layer can be obtained by applying an adhesive agent containing an adhesive main agent and a catalyst onto an adherend surface in the adhesive layer forming step, as described above. In this case, when an adherend having an adhesive layer and another adherend are laminated in the interposing step, an adhesive layer is interposed between the two adherends.

In the method (1), when one adherend having a catalyst impregnated main agent layer and other adherend are laminated, an adhesive layer is interposed between the two adherends. In the method (2), one adherend having a catalyst impregnated main agent layer obtained by applying a catalyst and then forming a main agent layer and other adherend are laminated, an adhesive layer is interposed between the two adherends. In the method (3), one adherend having a main agent layer obtained by applying an adhesive main agent onto the surface catalyst and other adherend in which a catalyst is applied onto the surface are laminated, an adhesive layer is interposed between the two adherends.

A method for applying an adhesive agent containing a catalyst onto an adherend surface and a method for applying an adhesive main agent onto an adherend surface or an adherend surface onto which the catalyst has been applied to form a main agent layer are not particularly limited. Examples of the methods include application methods using a roll coater, a bar coater, a wire bar coater, a curtain flow coater, and the like.

Further, a method for applying a catalyst onto a surface of the main agent layer or an adherend surface of the adherend is not particularly limited. A scat method, a spraying method such as air spraying, or brush coating may be applied.

In the adhesive layer forming step, when an adhesive main agent containing a thermoplastic resin having a crosslinkable group is subjected to conventionally publicly known method to form a film or sheet (that is a main agent film), and then a catalyst is applied onto at least one surface of an adherend, an adhesive layer (that is a catalyst added main agent film) can be obtained.

Whenr a catalyst is applied onto a sheet containing a thermoplastic resin having a crosslinkable group in the present invention, a crosslinked modified resin is formed. The catalyst is gradually impregnated into the sheet as time advances, and a crosslinked modified resin containing layer is formed having a thickness that the catalyst has impregnated. In the present invention, when the thermoplastic resin having a crosslinkable group is a polyolefin having an alkoxysilyl group, and |SP₁−SP₂| is 4.5 or less, and particularly 3 or less, a siloxane cross-link is efficiently progressed in depth direction of the sheet after contacting with catalyst. This means that “cross-linking depth” is high and the adhesive layer develops adhesiveness for a short time.

The pressing step is a step in which the two adherends and the adhesive layer are heated and pressed in a layer thickness direction. In this way, a laminated body is produced. In such a process, the adhesive or the adhesive main agent is cured due to a reduction in temperature or the like, and is further cured due to the promotion of a siloxane cross-link forming reaction (in case of a thermoplastic resin having an alkoxysilyl group) by the catalyst contained in the adhesive or the catalyst that comes into contact with and permeates into the adhesive main agent. Therefore, a time between the formation of an adhesive layer and bonding of two adherends with the adhesive layer interposed between them by heating and pressing, that is, an open time is limited.

When the open time is short, formation of an adhesive layer, lamination of adherends, heating and pressing of a laminate all need to be performed in a predetermined place. Therefore, for example, an adherend on which a main agent layer has been formed cannot be transferred to another place to perform lamination, heating, and pressing thereafter. For these reasons, the open time is preferably at least 2 hours, and particularly about 4 hours.

Further, a temperature of the adhesive layer during the pressing step is decreased unless heat is applied, and a cross-linking reaction is promoted by the action of the catalyst. Therefore, after the formation of the adhesive layer, the time between interposing the adhesive layer between two adherends and bonding the two adherends by heating and pressing, that is, the time corresponding to the open time is also limited.

A time between interposing the adhesive layer between two adherends and bonding the two adherends by heating and pressing cannot be made long, and may be, for example, 30 seconds to 2 to 3 minutes, but is often about 1 minute or shorter.

Further, the time after the adhesive layer is interposed between two adherends and the two adherends are bonded together by heating and pressing in a layer thickness direction and before a desired adhesive strength such as peel strength is developed, that is, an aging time is not particularly limited. From a practical viewpoint in industry, the aging time is preferably as short as possible. The aging time usually needs to be long when the adhesive layer is thick, but may be short when the adhesive layer is thin. For example, when the adhesive layer has a thickness of about 70 to 200 μm, particularly about 70 to 150 μm, the aging time is preferably about 240 hours or shorter, more preferably about 72 hours or shorter, and particularly about 24 hours or shorter.

### EXAMPLES

First, a correlation between ASP and a cross-linking depth will be explained.

### Experimental Examples 1 to 5

An adhesive main agent containing a modified polyolefin having an alkoxysilyl group (manufactured by H.B. Fuller under the trade name of “Swiftlock2003”) was used. This adhesive main agent has an SP value of 8.00.

The following catalysts (1) to (5) were used as catalysts. SP values of these catalysts are shown below, and absolute values of ASP representing a difference between the SP value of the catalyst and the SP value of the adhesive main agent are also shown in Table 1.

Catalyst (1) for Experimental Example 1
N,N,N′,N′-tetramethylethylenediamine
CAS110-18-9
SP value=7.73, N_{M}=116.21, (N_{H}/N_{M})×1000=17.21

Catalyst (2) for Experimental Example 2
1-(dimethylaminoethyl)-4-methylpiperazine
CAS104-19-8
SP value=8.89, N_{M}=171.28, (N_{H}/N_{M})×1000=17.51

Catalyst (3) for Experimental Example 3
Ethylenediamine
CAS107-15-3
SP value=10.9, N_{M}=60.10, (N_{H}/N_{M})×1000=33.28

Catalyst (4) for Experimental Example 4
N-(2-aminoethyl)piperazine
CAS140-31-8
SP value=10.9, N_{M}=129.21, (N_{H}/N_{M})×1000=23.22

Catalyst (5) for Experimental Example 5
2-aminoethanol
CAS141-43-5
SP value=12.8, N_{M}=61.08, (N_{H}/N_{M})×1000=32.74

In order to evaluate the correlation between ASP and a cross-linking depth, cross-linking depths were measured when the catalysts (1) to (5) were used among various catalysts.

Specifically, the adhesive main agent was heated at 180° C. and subjected to press-molding to form a sheet (adhesive main agent film) having a thickness of 600 μm. Subsequently, each of the catalysts was applied onto a surface of the sheet in an amount of 35 g/m² at a temperature of 23° C. After a lapse of 100 minutes from the application of the catalyst, an infrared imaging system (manufactured by PerkinElmer, Model “Spotlight 400”) was used to measure the maximum depth at which the concentration of the alkoxysilyl group (group linked to Si) contained in the adhesive main agent layer was detectable. The alkoxysilyl group becomes undetectable as the cross-linking of the modified polyolefin promotes, and therefore the detectable amount of the alkoxysilyl group reduces in proportion to the degree of promotion of the cross-linking of the modified polyolefin. In the Experimental Examples, a peak at a range from 1128 to 1057 cm⁻¹ was a characteristic peak, and the maximum depth (μm) at which this characteristic peak was detectable was measured. The results are shown in Table 1.

TABLE 1

| Experimental Example | ΔSP | Cross-linking depth (μm) |
|---|---|---|
| 1 | 0.27 | 386.29 |
| 2 | 0.89 | 244.63 |
| 3 | 2.90 | 41.53 |
| 4 | 2.90 | 48.03 |
| 5 | 4.80 | 0.00 |

As can be seen from the results shown in Table 1, in Experimental Examples 1 and 2 in which ΔSP was small, the cross-linking depth was very large, that is, cross-linking was sufficiently promoted in the thickness direction. Further, it can be seen that also in Experimental Examples 3 and 4 in which ΔSP was larger than that in Experimental Examples 1 and 2, the cross-linking depth was sufficiently large, that is, cross-linking was sufficiently promoted in the thickness direction. On the other hand, in Experimental Example 5 in which ΔSP exceeded the upper limit specified in the present invention, the value of cross-linking depth indicates that cross-linking did not occur at all, that is, the catalyst (5) is much inferior.

Next, production examples of the laminated body are described.

### Example 1

As two adherends, a polypropylene sheet having a thickness of 20 mm and a polyolefin-based elastomer sheet having a thickness of 25 mm were used. Onto the adherend surface of the polyolefin-based elastomer sheet, an adhesive (manufactured by H.B. Fuller under the trade name of “Swiftlock2003”) was applied with a roll coater at a temperature of 150° C. in an amount of 100 g/m² to form a main agent layer having a thickness of 100 μm. After a lapse of 30 minutes, the catalyst (3) used in Experimental Example 3 was applied as a catalyst by air spraying onto the surface of the main agent layer in an amount of 0.1 g/m². Then, after a lapse of 30 minutes from the application of the catalyst, the polypropylene sheet heated at 80° C. and the polyolefin-based elastomer sheet having a main agent layer formed thereon and heated at 100° C. were laminated and pressed at a pressure of 0.1 MPa for 15 seconds to produce a laminated body.

### Example 2

PET fibers and plant fibers were blended to form a web, and then these fibers were interlaced to form a fiber mat. Then, a dispersion obtained by dispersing a maleic anhydride-modified resin powder in water was applied onto and impregnated into the fiber mat to bind the interlaced fibers together to form a fiber assembly sheet having a thickness of 3 mm. The fiber assembly sheet was used as one of adherends. As the other adherend, a woven cloth obtained by weaving PET fibers was used. Then, a main agent layer was formed on the adherend surface of the fiber assembly sheet, and the catalyst (3) was applied onto the surface of the main agent layer. After a lapse of 30 minutes from the application of the catalyst, a laminated body was produced in the same manner as in Example 1 except that the woven cloth heated at 80° C. and the fiber assembly sheet having a main agent layer formed thereon and heated at 100° C. were laminated and pressed. This laminated body can be used as an interior material such as a door trim for vehicles.

### Example 3

A laminated body was produced in the same manner as those in Example 2 except that the catalyst (3) was used instead of catalyst (2). Similar to the laminated body of Example 2, this laminated body was also useful as an interior material such as a door trim for vehicles.

### Example 4

An adhesive (manufactured by H.B. Fuller under the trade name of “Swiftlock2003”) was heated at a temperature of 180° C. and was subjected to press-molding to form a sheet (main agent film) having a thickness of 120 μm. Subsequently, the catalyst (3) used in Experimental Example 3 was applied onto both surfaces of the main agent film so that coating amount in both becomes 0.1 g/m². After a lapse of 30 minutes, the main agent film with the catalyst was heated at 100° C. The main agent film with the catalyst was set between a fiber assembly sheet used in Example 2 and a woven cloth heated at 80° C. These were then pressed and a laminate body was obtained. Similar to the laminated body of Examples 2 and 3, this laminated body was also useful as an interior material such as a door trim for vehicles.

### Example 5

PET fibers and carbon fibers were blended to form a web, and then these fibers were interlaced to form a fiber mat. Then, a dispersion obtained by dispersing a maleic anhydride-modified resin powder in water was applied onto and impregnated into the fiber mat to bind the interlaced fibers together to form a fiber assembly board having a thickness of 5 mm. The fiber assembly board was used as one of adherends. As the other adherend, a PET film having a thickness of 2 mm was used. Further, onto the adherend surface of the fiber assembly board, a main agent layer was formed, and the catalyst (3) was applied onto the surface of the main agent layer. After a lapse of 30 minutes from the application of the catalyst, a laminated body was produced in the same manner as in Example 1 except that the PET film heated at 80° C. and the fiber assembly board having a main agent layer formed thereon and heated at 100° C. were laminated and pressed. This laminated body can be used as an exterior material of an architectural structure.

### Example 6

A laminated body was produced in the same manner as in Example 5 except that the catalyst (3) was used instead of the catalyst (2). Similar to the laminated body of Example 5, this laminated body was also useful as an exterior material of an architectural structure.

### Example 7

An adhesive (manufactured by H.B. Fuller under the trade name of “Swiftlock2003”) was heated at a temperature of 180° C. and was subjected to press-molding to form a sheet (main agent film) having a thickness of 120 μm. Subsequently, the catalyst (2) used in Experimental Example 2 was applied onto both surfaces of the main agent film so that coating amount in both becomes 0.1 g/m². After a lapse of 30 minutes, the main agent film with the catalyst was heated at 100° C. The main agent film with the catalyst was set between a fiber assembly board used in Example 5 and a PET film heated at 80° C. These were then pressed and a laminate body was obtained. Similar to the laminated body of Examples 5 and 6, this laminated body was also useful as an exterior material of an architectural structure.

It is to be noted that the foregoing examples have been provided merely for the purpose of explaining and are in no way to be construed as limiting of the present invention. While the present invention has been described with reference to exemplary embodiments, it is understood that the words used herein are words of description and illustration, rather than words of limitation. Changes may be made within the purview of the appended claims, as presently stated and as amended, without departing from the scope and spirit of the present invention in its aspects. Although the present invention has been described herein with reference to particular structures, materials, and embodiments, the present invention is not intended to be limited to the particulars disclosed herein; rather the present invention extends to all functionally equivalent structures, methods, and uses, such as are within the scope of the appended claims.

The laminated body and the method for producing the same according to the present invention can be used in various technical fields. More specifically, the laminated body and the method for producing the same according to the present invention can suitably be used in technical fields involving laminated bodies for use in various industries such as interior and exterior materials for vehicles such as automobiles and railway vehicles and interior and exterior materials of airplanes, boats and ships, and buildings.

What is claimed is:

1. A laminated body comprising two adherends and an adhesive layer that is interposed between these adherends to bond them together,
wherein the adhesive layer comprises
a cross-linked modified resin obtained by forming a cross-link derived from a cross-linkable group of a thermoplastic resin having the cross-linkable group, and
a catalyst impregnated into the cross-linked modified resin,
wherein the catalyst promotes formation of a cross-link derived from the cross-linkable group in the thermoplastic resin, and
wherein when a solubility parameter of an adhesive main agent containing the thermoplastic resin having the cross-linkable group is defined as SP₁ and a solubility parameter of the catalyst is defined as SP₂, |SP₁−SP₂| is 4.5 or less.

2. The laminated body according to claim 1, wherein at least one of the two adherends has a porous adherend surface.

3. The laminated body according to claim 2, wherein the adherend is at least one of a fiber assembly sheet, a fiber assembly board, and a resin board.

4. The laminated body according to claim 2, wherein the adherend is at least one of a woven cloth, a knitted cloth, and a non-woven cloth.

5. The laminated body according to claim 2, which is an interior material.

6. The laminated body according to claim 2, which is an exterior material.

7. The laminated body according to claim 1, wherein the |SP₁−SP₂| is 3 or less.

8. The laminated body according to claim 2, wherein the |SP₁−SP₂| is 3 or less.

9. The laminated body according to claim 1, wherein the catalyst is a compound having a molecular weight of 500 or less.

10. The laminated body according to claim 2, wherein the catalyst is a compound having a molecular weight of 500 or less.

11. The laminated body according to claim 1, wherein the catalyst is an amine-based compound.

12. The laminated body according to claim 2, wherein the catalyst is an amine-based compound.

13. The laminated body according to claim 11, wherein the amine-based compound is at least one selected from a group consisting of bis-(2-dimethylaminoethyl) ether, N,N, N′,N′-tetramethylhexamethylenediamine, 1-methyl-4′-(dimethylaminoethyl)piperazine, N,N,N′,N′-tetramethylethylenediamine, and N,N-dimethyldodecylamine.

14. The laminated body according to claim 12, wherein the amine-based compound is at least one selected from a group consisting of bis-(2-dimethylaminoethyl) ether, N,N, N′,N′-tetramethylhexamethylenediamine, 1-methyl-4′-(dimethylaminoethyl)piperazine, N,N,N′,N′-tetramethylethylenediamine, and N,N-dimethyldodecylamine.

15. The laminated body according to claim 1, wherein the thermoplastic resin having the cross-linkable group is a polyolefin having an alkoxysilyl group.

16. The laminated body according to claim 1, wherein the adhesive layer has a thickness of 10 to 500 μm.

17. A method for producing a laminated body according to claim 1, the method comprising:
an adhesive layer forming step in which a thermoplastic resin having a cross-linkable group and a catalyst are used to form an adhesive layer;
an interposing step in which the adhesive layer is interposed between two adherends; and
a pressing step in which the two adherends and the adhesive layer are heated and pressed in a layer thickness direction,
wherein when a solubility parameter of an adhesive main agent containing the thermoplastic resin having a cross-linkable group is defined as SP₁ and a solubility parameter of the catalyst is defined as SP₂, |SP₁−SP₂| is 4.5 or less.

18. The method for producing a laminated body according to claim 17, wherein the thermoplastic resin having the cross-linkable group is a polyolefin having an alkoxysilyl group.
